(19) United States
(12) Patent Application Publication
(10) Pub. No.: US 2017/0255142 A1
(43) Pub. Date: Sep. 7, 2017

(54) FIXING DEVICE AND IMAGE FORMING APPARATUS INCLUDING THE SAME

(71) Applicant: KYOCERA Document Solutions Inc., Osaka (JP)

(72) Inventor: Tatsuya YAMANAKA, Osaka-shi (JP)

(73) Assignee: KYOCERA Document Solutions Inc., Osaka (JP)

(21) Appl. No.: 15/416,372

(22) Filed: Jan. 26, 2017

(30) Foreign Application Priority Data
Mar. 1, 2016 (JP) 2016-038532

(51) Int. Cl. G03G 15/20

(52) U.S. Cl. CPC G03G 15/2039

(57) ABSTRACT

A fixing device includes a fixing member, a pressuring member a cooling part and a control part. The fixing member is heated by a heat source. The pressuring member comes into pressure contact with the fixing member to form a fixing nip. The cooling part cools the pressuring member heated via the fixing member. The control part controls the cooling part. The fixing member and the pressuring member are rotatable and fix a toner image at least one of a front face and a rear face of a sheet passing through the fixing nip. The cooling part is controlled by the control part to lower a temperature of the pressuring member at a first fixing processing in which the toner image is fixed on the front face of the sheet compared with a second fixing processing in which the toner image is fixed on the rear face of the sheet.

### INCORPORATION BY REFERENCE

This application is based on and claims the benefit of priority from Japanese Patent application No. 2016-038532 filed on Mar. 1, 2016, which is incorporated by reference in its entirety.

### BACKGROUND

The present disclosure relates to a fixing device which fixes a toner image on a sheet and an image forming apparatus including the fixing device.

An electrophotographic type image forming apparatus is provided with a fixing device having a pressuring roller which comes into pressure contact with a fixing roller (a heating roller). The fixing device heats and presses a sheet passing through a gap (a fixing nip) between the both rollers to fix a toner image on the sheet (a fixing processing). The sheet enters the fixing nip with a face having a transferred toner image facing the fixing roller.

By the way, some image forming apparatuses can perform an image forming on both faces of the sheet (a duplex printing). In such an image forming apparatus, the fixing device fixes a transferred toner image on a first face (a front face) of the sheet (a first fixing processing). After the first fixing processing, the both faces of the sheet is reversed and then the fixing device fixes a transferred toner image on a second face (a rear face) of the sheet (a second fixing processing). Here, the sheet sometimes curls with the face facing the pressuring roller rolled inward because a temperature of the pressuring roller is lower than a temperature of the fixing roller. A degree of the curl (curling) becomes remarkable in cases where an amount of moisture contained in the sheet increases (a moisture content is higher) or a temperature difference between the fixing roller and the pressuring roller is large.

The sheet after the first fixing processing curls with the rear face rolled inward. Because the second processing is performed after the both faces of the sheet is reversed, the sheet enters the fixing nip with the face facing the fixing roller rolled inward at the second fixing processing. Then, the sheet is curled with the face facing the pressuring roller rolled inward so as to cancel the curl occurred in the first fixing processing. However, because the sheet is heated at the first fixing processing and the moisture content of the sheet decreases, a degree of the curl at the second fixing processing is smaller than the degree of the curl at the first fixing processing. As a result, the sheet is ejected on an ejection tray with the face facing the fixing roller rolled inward (the rear face rolled inward). Then, various problems, such as a stacking failure of the sheet on the ejection tray or a conveying failure (jamming) of the sheet after the fixing processing, may occur.

In order to solve the above problems, some techniques are proposed. For instance, a fixing device which controls a temperature of the sheet at an image forming is proposed. The fixing device controls the temperature such that a rear end portion of the first face (the front face) is heated at 160° C. and another portion of the first face is heated at a conventionally temperature of 190° C. As a result, a degree of the curl on the rear end portion of the sheet becomes small. Although the sheet is conveyed with the curled portion of the sheet first at the image forming on the second face (the rear face), the degree of the curl of the sheet is small so that the conveying failure of the sheet can be restricted.

### SUMMARY

In accordance with an aspect of the present disclosure, a fixing device includes a fixing member, a pressuring member a cooling part and a control part. The fixing member is heated by a heat source. The pressuring member comes into pressure contact with the fixing member to form a fixing nip. The cooling part cools the pressuring member heated via the fixing member. The control part controls the cooling part. The fixing member and the pressuring member are rotatable and fix a toner image at least one of a front face and a rear face of a sheet passing through the fixing nip. The cooling part is controlled by the control part to lower a temperature of the pressuring member at a first fixing processing in which the toner image is fixed on the front face of the sheet compared with a second fixing processing in which the toner image is fixed on the rear face of the sheet.

The above and other objects, features, and advantages of the present disclosure will become more apparent from the following description when taken in conjunction with the accompanying drawings in which a preferred embodiment of the present disclosure is shown by way of illustrative example.

### BRIEF DESCRIPTION OF THE DRAWINGS

FIG. 1 is a sectional view schematically showing an inner structure of a multifunctional peripheral according to a first embodiment of the present disclosure.

FIG. 2 is a sectional view schematically showing a fixing device (a first fixing processing) according to a first embodiment of the present disclosure.

FIG. 3 is a sectional view schematically showing a cooling part of the fixing device according to the first embodiment of the present disclosure.

FIG. 4 is a block diagram showing a control system of the fixing device according to the first embodiment of the first present disclosure.

FIG. 5 is a sectional view schematically showing the fixing device (a second fixing processing) of the fixing device according to the first embodiment of the present disclosure.

FIG. 6 is a graph showing temperatures of a fixing roller and a pressuring roller of the fixing device according to the first embodiment of the present disclosure.

FIG. 7 is a sectional view schematically showing the fixing device according to a second embodiment of the present disclosure.

FIG. 8 is a sectional view schematically showing the fixing device according to a third embodiment of the present disclosure.

### DETAILED DESCRIPTION

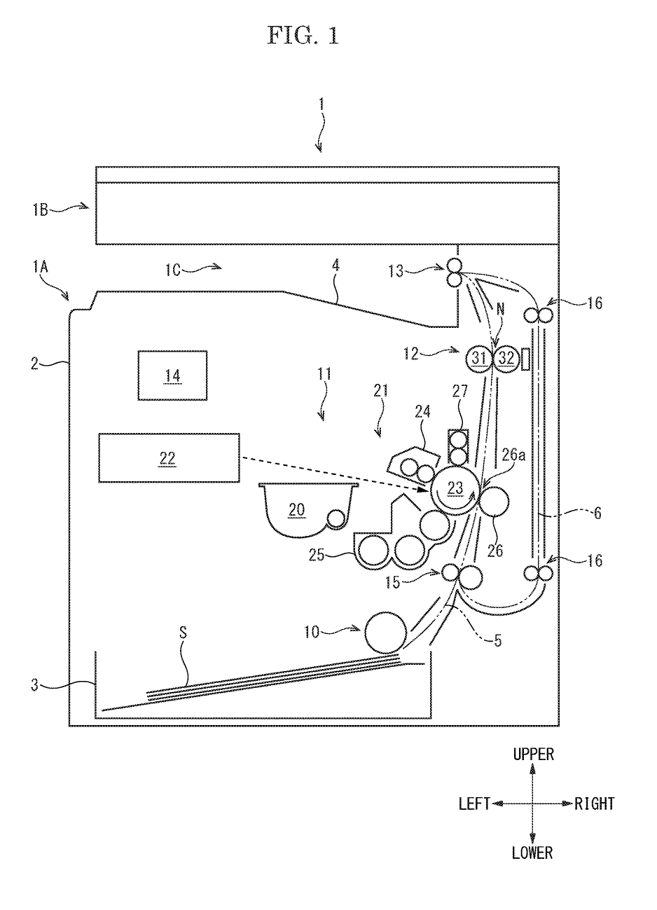

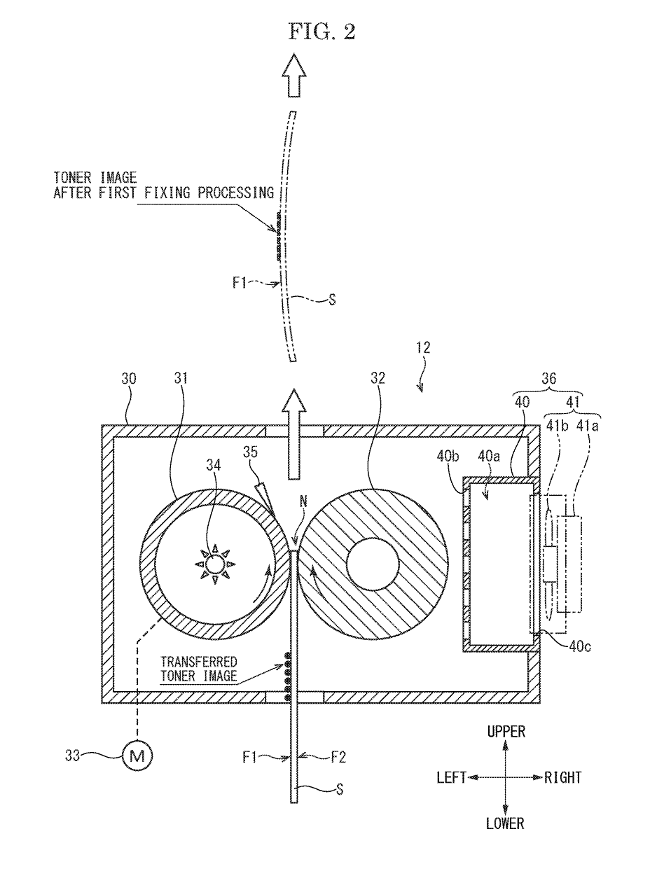

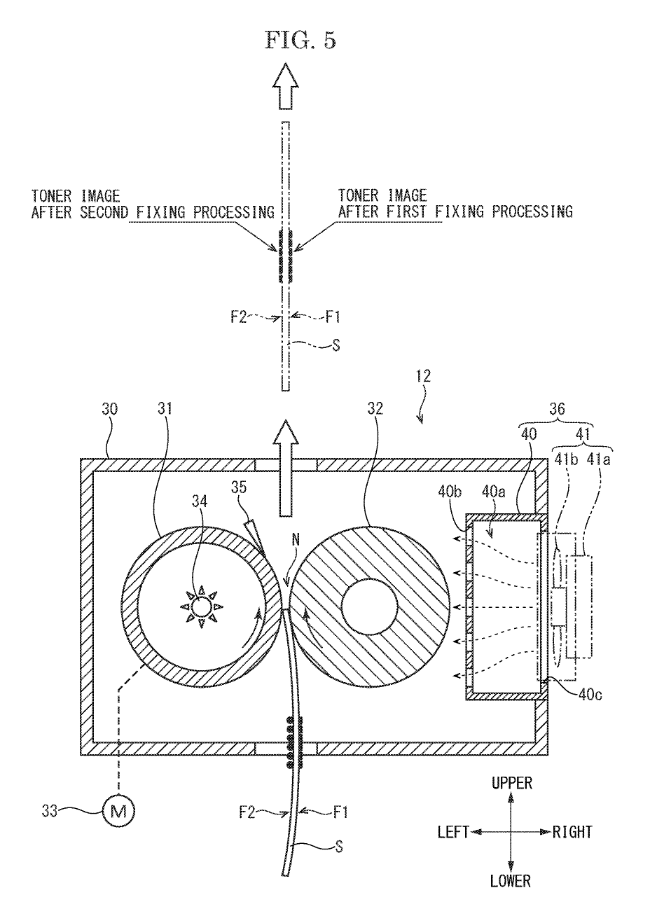

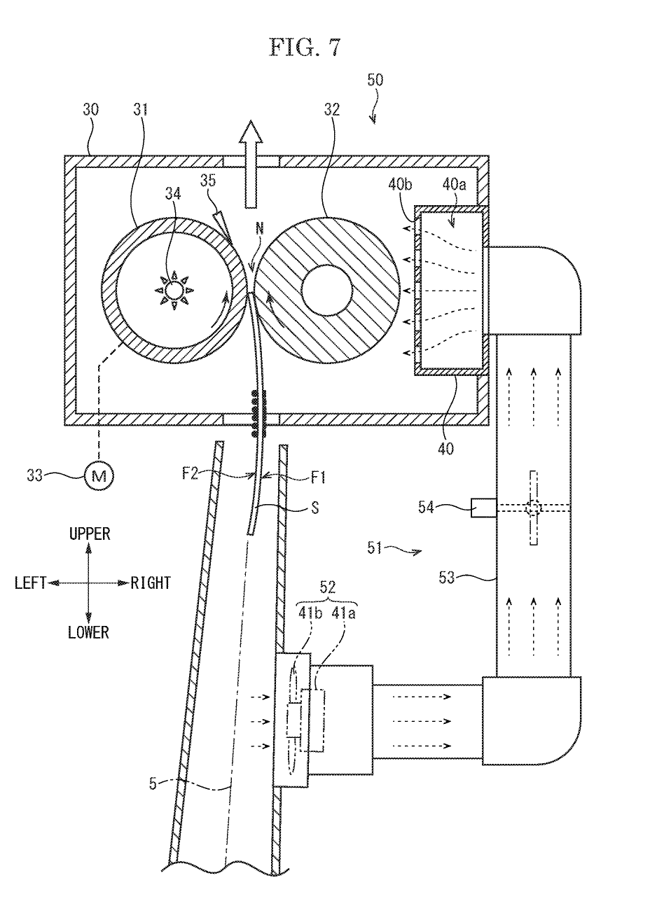

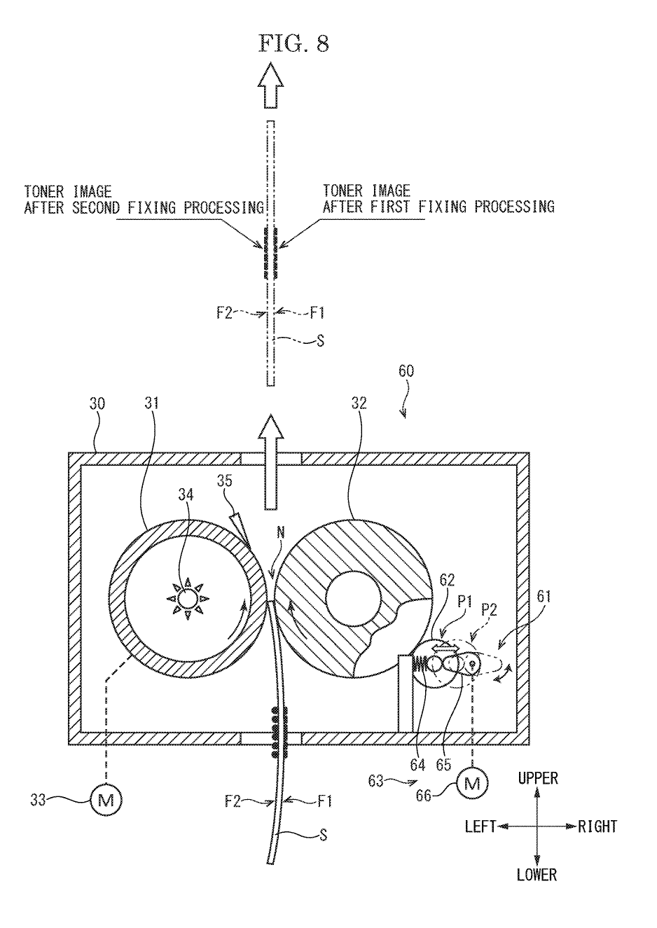

Hereinafter, with reference to figures, a preferred embodiment of the present disclosure will be described. A front side on the paper plan of FIG. 1, FIG. 2, FIG. 5, FIG. 7 and FIG. 8 shows a front side, and the following description is based on directions shown in each figure. In the following description, “a conveying direction” shows a conveying direction of a sheet S. In addition, “an upstream”, “a downstream” and other similar description respectively show “an upstream” side in the conveying direction, “a downstream” side in the conveying direction and other similar concept.

With reference to FIG. 1, a multifunctional peripheral 1 that is an image forming apparatus according to a first embodiment will be described. FIG. 1 is a sectional view schematically showing an inner structure of the multifunctional peripheral 1.

The multifunctional peripheral 1 includes a printing apparatus 1A and a scanning apparatus 1B. The printing apparatus 1A forms an image on a sheet S in an electrophotographic manner. The scanning apparatus 1B has a component (not shown) which optically reads image date of a document. The scanning apparatus 1B is disposed on the printing apparatus 1A via an in-body space 1C. The scanning apparatus 1B has a known configuration and its detailed description is omitted.

The printing apparatus 1A has an apparatus main body 2, a sheet feeding cassette 3 and an ejection tray 4. The sheet feeding cassette 3 is provided in a lower portion of the apparatus main body 2 so as to be detachably attached in the front and rear direction. In the sheet feeding cassette 3, the sheets S (a bundle of sheets) are stored. The ejection tray 4 is formed on an upper face of the apparatus main body 2 (a bottom face of the in-body space 1C).

Inside of the apparatus main body 2, a main conveying path 5 and an inversion path 6 are formed. The main conveying path 5 extends in a vertical direction from the sheet feeding cassette 3 to the ejection tray 4. The inversion path 6 extends in the vertical direction so as to connect an upstream portion and a downstream portion of the main conveying path 5.

The printing apparatus 1A has a sheet feeding part 10, an image forming part 11, a fixing device 12, a pair of ejection rollers 13 and a control device 14. The sheet feeding part 10 is disposed on an upstream end portion of the main conveying path 5. The sheet feeding part 10 feeds the sheet S stored in the sheet feeding cassette 3 toward the main conveying path 5 one by one. The image forming part 11 and the fixing device 12 are disposed on a middle portion of the main conveying path 5. The pair of ejection rollers 13 is disposed on a downstream end portion of the main conveying path 5. The control device 14 (a control part) totally controls an operation of the multifunctional peripheral 1.

The image forming part 11 transfers a toner image on the sheet S. The image forming part 11 has a toner container 20, a drum unit 21 and an optical scanning device 22. The toner container 20 contains a toner (a developer) of black color, for example. The drum unit 21 has a photosensitive drum 23, a charging device 24, a development device 25, a transferring roller 26 and a cleaning device 27. The charging device 24, the development device 25, the transferring roller 26 and the cleaning device 27 are disposed around the photosensitive drum 23 in the order of transferring process. The transferring roller 26 comes into pressure contact with the photosensitive drum 23 from the right side to form a transferring nip 26a.

The fixing device 12 has a pressuring roller 32 which comes into pressure contact with a fixing roller 31 to form a fixing nip N, as described later in detail. The fixing roller 31 and the pressuring roller 32 heat and press the sheet S passing through the fixing nip N to fix the toner image on at least one of a front face F1 and a second face F2 of the sheet S.

The pair of ejection rollers 13 is disposed in an upper portion of the apparatus main body 2. A driving roller (not shown) of the pair of ejection rollers 13 is driven by a motor (not shown) to be rotated normally and reversely. A driven roller (not shown) of the pair of ejection rollers 13 is driven by the driving roller. The pair of ejection rollers 13 holds the sheet S between them and conveys the sheet S to a downstream side in the rotation direction of the pair of ejection rollers 13. In detail, when the pair of ejection rollers 13 is rotated normally, the sheet S on which an image is formed is fed from the main conveying path 5 toward the in-body space 1C (the ejection tray 4). On the other hand, when the pair of ejection rollers 13 is rotated reversely, the sheet S which has an image on the front face Fl (a first face) is reversed toward the inversion path 6.

On the main conveying path 5, a pair of resist rollers 15 is rotatably disposed between the sheet feeding part 10 and the image forming part 11 (the transferring nip 26a). The pair of resist rollers 15 holds the sheet S between them and conveys the sheet S to a downstream side in the rotation direction of the pair of resist rollers 15. In addition, the pair of the resist rollers 15 stops the conveying of the sheet S temporarily to align a front edge of the sheet S. The inversion path 6 is branched from a downstream portion of the main conveying path 5, extends downward and then is joined to the main conveying path 5 closer to the upstream side than the pair of resist rollers 15. Along the inversion path 6, a plurality of conveying rollers 16 are rotatably disposed. Each of the pairs of conveying rollers 16 holds the sheet S and conveys the sheet S to a downstream side of the rotation direction of the pair of conveying rollers 16. The pair of resist rollers 15 and each of the pairs of conveying rollers 16 each have a driving roller (not shown) driven by a motor (not shown) to be rotated and a driven roller (not shown) driven by the driving roller to be rotated.

Here, an operation of the printing apparatus 1A will be described. The control device 14 executes the following image forming operation based on the image date read by the scanning apparatus 1B.

The charging device 24 charges a surface of the photosensitive drum 23. The optical scanning device 22 exposes the photosensitive drum 23 based on the image data (refer to a dashed arrow in FIG. 1). The development device 25 develops a latent image on the photosensitive drum 23 into a toner image. On the other hand, the sheet S is conveyed from the sheet feeding part 10 to the main conveying path 5. The toner image is transferred on the front face F1 (the first face) of the sheet S passing through the transferring nip 26a. The fixing device 12 fixes the toner image on the front face F1 of the sheet S (a first fixing processing). After the first fixing processing, the sheet S is ejected by the pair of ejection rollers 13 on the ejection tray 4.

When an image is formed on both of the front and rear faces of the sheet S (a duplex printing), after the first fixing processing, the sheet S is reversed by the pair of ejection rollers 13 and then fed toward the inversion path 6. The sheet S of which the front and rear faces are reversed is conveyed from the inversion path 6 to the main conveying path 5. The toner image formed on the photosensitive drum 23 is transferred on the rear face F2 (the second face) of the sheet S passing through the transferring nip 26a. The fixing device 12 fixes the toner image on the rear face F2 of the sheet S (a second fixing processing). The sheet S having the image on the both faces is ejected on the ejection tray 4.

Next, with reference to FIG. 2, the fixing device 12 will be described. FIG. 2 is a sectional view schematically showing the fixing device 12.

The fixing device 12 has a fixing frame 30, a fixing roller 31, a pressuring roller 32, a fixing motor 33 and a heater 34.

The fixing roller 31 that is a fixing member is formed into a cylindrical shape elongated in the front and rear directions. The fixing roller 31 is rotatably supported by the fixing frame 30. The fixing roller 31 is formed by laminating a releasing layer (a fluororesin layer, not shown) on a circumferential face of a core material (not shown) made of metal (aluminum or steel), for example.

The pressuring roller 32 that is a pressuring member is formed into a cylindrical shape elongated in the front and rear directions. The pressuring roller 32 is rotatably supported by the fixing frame 30. The fixing roller 31 is formed by laminating an elastic layer (a silicon rubber layer, not shown) on a circumferential face of a core material (not shown) made of metal (aluminum or steel), for example. The pressuring roller 32 has a releasing layer (a fluororesin layer, not shown) formed on a circumferential face of the elastic layer. The pressuring roller 32 is biased by a biasing member (not shown) to come into pressure contact with the fixing roller 31. The fixing nip N is formed between the fixing roller 31 and the pressuring roller 32.

The fixing motor 33 is connected to the fixing roller 31 via a gear train. The fixing motor 33 drives the fixing roller 31 to be rotated around an axis. The pressuring roller 32 is driven by the fixing roller 31 to be rotated in a direction opposing to the rotation direction of the fixing roller 31.

The heater 34 that is a heat source is a halogen heater or a ceramics heater, for example. The heater 34 is disposed in a hollow space of the fixing roller 31. The heater 34 heats the fixing roller 31. The pressuring roller 32 is heated by the fixing roller 31 heated by the heater 34.

The sheet S passes through the fixing nip N with the face having the transferred toner image facing the fixing roller 31. Thereby, the toner image (the toner which forms the toner image) is melted and pressed to be fixed on the front face F1 or the rear face F2 of the sheet S. On the downstream side of the fixing nip N, a separating claw 35 is disposed. The separating claw 35 is configured to be close to or separate from a circumferential outer face of the fixing roller 31. The separating claw 35 separates the sheet S from the circumferential outer face of the fixing roller 31.

Because the pressuring roller 32 is indirectly heated by the heater 34, a temperature of the pressuring roller 32 is lower than a temperature of the fixing roller 31. The sheet S subjected to the fixing processing curls with the face facing the low temperature pressuring roller 32 rolled inward (refer to the sheet S shown by a two-dotted line in FIG. 2). A degree of the curl increase almost in proportion to increase in an amount of moisture contained in the sheet S (a moisture content) or a temperature difference between the both rollers 31 and 32.

Here, a case where the duplex printing is preformed will be explained. Because the sheet S subjected to the first fixing processing has a relatively high moisture content, a degree of the curl of the sheet S after the first fixing processing is large. At the first fixing processing, the sheet S is heated and thus a moisture content of the sheet S decreases. Accordingly, a degree of the curl of the sheet S at the second fixing processing becomes lower than the degree of the curl of the sheet S at the first fixing processing. As a result, after the duplex printing, the curl occurred at the first fixing processing is left on the sheet S. That is, the sheet S having the image on the both faces is ejected on the ejection tray 4 with the face facing the fixing roller 31 rolled inward. Then, a stacking failure of the sheet S or a jamming on the downstream side of the fixing device 12 may occur.

The fixing device 12 according to the first embodiment has a configuration which increase a temperature difference between the both rollers 31 and 32. Specifically, the fixing device 12 has a cooling part 36 which cools the pressuring roller 32, heated via the fixing roller 31, at the second fixing processing.

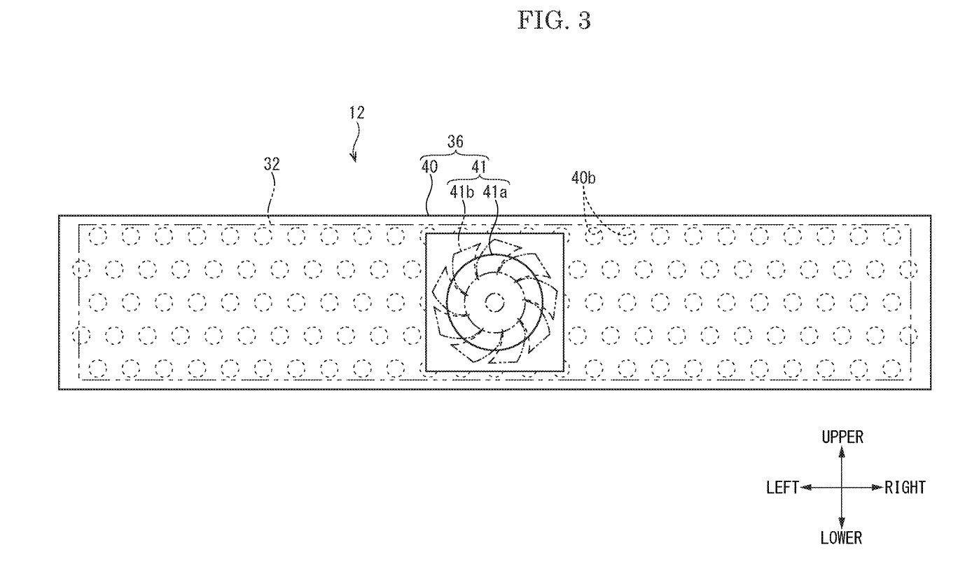

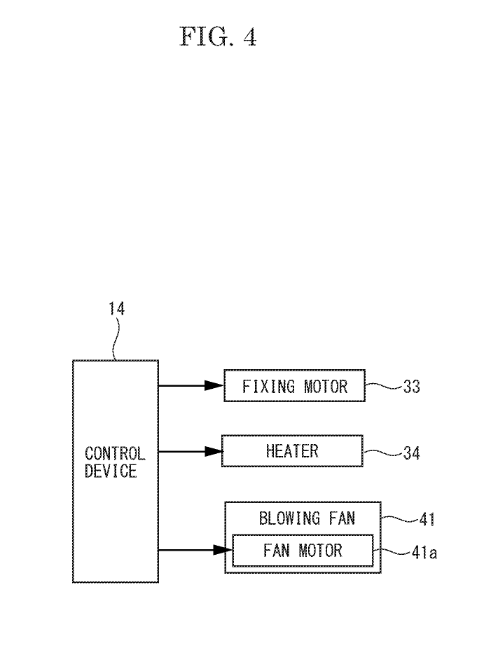

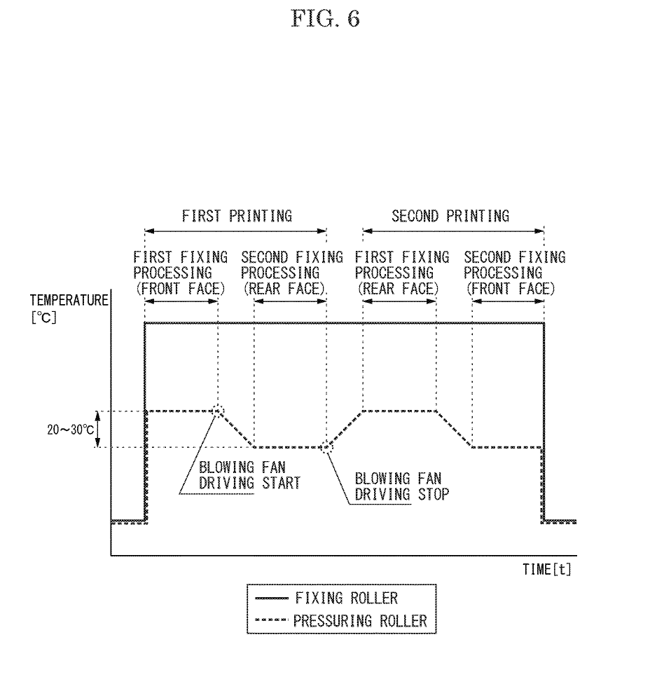

Hereinafter, with reference to FIGS. 2 to 6, the cooling part 36 of the fixing device 12 will be described. FIG. 3 is a side view schematically showing the cooling part 36. FIG. 4 is a block diagram showing a control system of the fixing device 12. FIG. 5 is a sectional view schematically showing the fixing device 12 (at the second fixing processing). FIG. 6 is a graph showing temperatures of the fixing roller 31 and the pressuring roller 32.

As shown in FIGS. 2 and 3, the cooling part 36 has a blowing case 40 and a blowing fan 41. The blowing fan 41 is configured to be capable of blowing cool air toward the pressuring roller 32 through the blowing case 40, as described later in detail.

The blowing case 40 is formed into a substantially parallelepiped rectangular shape elongated in the front and rear directions. The blowing case 40 is supported by the fixing frame 30 at a position facing the pressuring roller 32. That is, the blowing case 40 is disposed on the opposing side to the fixing roller 31 via the pressuring roller 32 (refer to FIG. 2). Inside of the blowing case 40, a blowing space 40a is formed (refer to FIG. 2). On a left wall of the blowing case 40, a plurality of blowing holes 40b are formed. The blowing holes 40b are arranged in zigzag within an area facing the pressuring roller 32 (refer to FIG. 3). The blowing holes 40b may be arranged in lattice.

The blowing fan 41 is fixedly attached to a center portion in the front and rear directions of a right wall of the blowing case 40. The blowing fan 41 is fitted into a fitting opening 40c formed in the right wall of the blowing case 40 (refer to FIG. 2). The blowing fan 41 has an impeller 41b which is driven by a fan motor 41a to be rotated. On rotating the impeller 41b, an air flow (a cooling air flow) toward the blowing space 40a is produced.

The control device 14 as described above has an arithmetic processing part (not shown) executing an arithmetic processing based on program stored in a storage part (not shown). As shown in FIG. 4, the fixing motor 33, the heater 34, the fan motor 41a and the others (each device and the others) are electrically connected to the control device 14. The control device 14 controls each device appropriately. The other devices (not shown) required to perform the image forming operation are also electrically connected to the control device 14 to be controlled.

Next, a temperature control of the pressuring roller 32 at the duplex printing will be described.

The control device 14 executes the image forming operation as described above. First, the sheet S fed from the sheet feeding part 10 is conveyed to the image forming part (the transferring nip 26a). The toner image on the photosensitive drum 23 is transferred on the front face F1 (the first face) of the sheet S (refer to FIG. 1). The control device 14 controls the fixing motor 33 and the heater 34 to be driven. The fixing device 12 fixes the toner image on the front face F1 of the sheet S (refer to FIG. 2). That is, the fixing device 12 performs the first fixing processing. In a period before the performing of the first fixing processing until the middle of the performing, the control device 14 controls the blowing fan 41 of the cooling part 36 to be stopped.

After that, the sheet S of which the both faces are reversed after the first fixing processing is conveyed to the image forming part 11 (the transferring nip 26a) again. The toner image on the photosensitive drum 23 is transferred on the rear face F2 (the second face) of the sheet S and then fixed on the rear face F2 of the sheet S by the fixing device 12 (refer to FIG. 5). That is, the fixing device 12 performs the second fixing processing. Just after the end of the first fixing processing, the control device 14 starts to control the blowing fan 41 to be driven (refer to FIG. 6). The blowing fan 41 may start the driving in a period from the end of the first fixing processing until the start of the second fixing processing.

As shown in FIG. 5, the cooling airflow produced by the blowing fan 41 is distributed in the blowing space 40a and then blown on the pressuring roller 32 through the blowing holes 40b. The cooling air flow passing through the blowing holes 40b is blown on an entire area of the pressuring roller 32 in the length direction. As a result, the pressuring roller 32 is cooled almost uniformly in the length direction. As shown in FIG. 6, the cooling part 36 is controlled by the control device 14 to cool the pressuring roller 32 such that a temperature of the pressuring roller 32 at the second fixing processing is lower than a temperature of the pressuring roller 32 at the first fixing processing. The heater 34 is controlled by the control device 14 to keep the temperature of the fixing roller 31 constant. The temperature of the pressuring roller 32 at the second fixing processing is preferably lower than that at the first fixing processing by 20 to 30 degree (Celsius).

When the second fixing processing is ended, the control device 14 controls the blowing fan 41 to be stopped. By the above operation, the duplex printing for the first sheet S is completed. The duplex printing for the second sheet S is controlled in the same way.

According to the fixing device 12 of the first embodiment as described above, the pressuring roller 32 is indirectly heated by the hater 34 and cooled by the blowing fan 41 of the cooling part 36. As shown in FIG. 6, the temperature of the pressuring roller 32 at the second fixing processing is set to be lower than the temperature of the pressuring roller at the first fixing processing. Accordingly, the temperature difference between the fixing roller 31 and the pressuring roller 32 increases at the second fixing processing. When the second fixing processing is performed by using the fixing roller 31 and the pressuring roller 32 which have a large temperature difference, the sheet S of which moisture content decreases after the first fixing processing curls largely. This makes it possible to decrease a difference in a curl amount of the sheet S between at the first fixing processing and at the second fixing processing. That is, the curl occurred at the first fixing processing can be canceled by the second fixing processing (refer to the sheet S shown in a two-dotted line in FIG. 5). Therefore, the curl amount of the sheet S having the toner image on the both faces decreases so that the stacking failure of the sheet S on the ejection tray 4 or the conveying failure of the sheet S after the second fixing processing can be restricted.

Furthermore, according to the fixing device 12 of the first embodiment, by controlling a revolution speed of the blowing fan 41, the temperature of the pressuring roller 32 can be controlled. For instance, increasing of the revolution speed of the blowing fan 41 can increase a lowering degree of the temperature of the pressuring roller 32. Alternatively, stopping the blowing fan 41 (or reducing the revolution speed of the blowing fan 41) can decrease the lowering degree of the temperature of the pressuring roller 32. In this way, it becomes possible to control the temperature difference between the fixing roller 31 and the pressuring roller 32 easily. That is, it becomes possible to control the curl amount of the sheet S at each of the first fixing processing and the second fixing processing. In the first embodiment, the blowing fan 41 is stopped at the first fixing processing; the blowing fan 41 may be driven at a slow revolution speed.

The fixing device 12 of the first embodiment has a single blowing fan 41; the present disclosure is not limited to the first embodiment. For instance, a plurality of blowing fans 41 may be arranged adjacently along the length direction (the front and rear direction) of the pressuring roller 32. In this case, the blowing case 40 may not be provided.

Next, with reference to FIG. 7, a fixing device 50 of a second embodiment will be described. FIG. 7 is a sectional view schematically showing the fixing device 50. In the following description, the same structures as those of the fixing device 12 of the first embodiment are shown by the same reference numbers as those of the first embodiment and their detail descriptions are omitted.

A cooling part 51 of the fixing device 50 includes a blowing case 40, a blowing fan 52, a blowing duct 53 and a regulating valve 54.

The blowing fan 52 is disposed on the main conveying path 5 between the transferring nip 26a and the fixing nip N, for instance. The blowing fan 52 produces an air flow (a cooling air flow) toward outside (the right side) from the inside of the main conveying path 5. That is, the blowing fan 52 acts suction force on the sheet S conveyed along the main conveying path 5. This can stabilize behavior of the sheet S conveyed along the main conveying path 5.

The blowing duct 53 communicates the blowing case 40 to the blowing fan 52. The blowing duct 53 is configured to introduce air (cooling air) discharged from the blowing fan 52 into the blowing case 40.

The regulating valve 54 is provided on the blowing duct 53 in order to regulate an air flow (the cooling air). The regulating valve 54 is configured to close and open the blowing duct 53. The regulating valve 54 is driven by an electric motor (not shown) to close and open the blowing duct 53. The blowing fan 52 and the regulating valve 54 (the electrical motor) are electrically connected to the control device 14 to be controlled appropriately.

Next, the temperature control of the pressuring roller 32 at the duplex printing will be described. The description for the same temperature control as that of the first embodiment is omitted.

When the executing of the image forming operation is started, the control device 14 starts to control the blowing fan 52 of the cooling part 51 to be driven in order to stabilize the behavior of the sheet S conveyed along the main conveying path 5. In this time, the regulating valve 54 of the cooling part 51 is controlled by the control device 14 to close the blowing duct 53 (refer to a dashed line in FIG. 7). The toner image on the photosensitive drum 23 is transferred on the front face F1 of the sheet S and then subjected to the first fixing processing by the fixing device 50. Because the blowing duct 53 is closed during the performing of the first fixing processing, the pressuring roller 32 is not cooled by the cooling air.

After that, the toner image on the photosensitive drum 23 is transferred on the rear face F2 of the sheet S and then subjected to the second fixing processing by the fixing device 50. In this time, the control device 14 continues the control to drive the blowing fan 52. Just after the end of the first fixing processing, the control device 14 starts to control the regulating valve 54 to be driven to open the blowing duct 53 (refer a two-dotted line in FIG. 7). The cooling air produced by the blowing fan 52 is introduced through the blowing duct 53 into the blowing case 40. The cooling air is distributed in the blowing case 40 and blown on the pressuring roller 32 though the blowing holes 40b. The regulating valve 54 may be driven to open the blowing duct 53 in a period from the end of the first fixing processing until the start of the second fixing processing.

According to the fixing device 50 of the second embodiment as described above, the same effect as that of the fixing device 12 of the first embodiment can be obtained.

Next, with reference to FIG. 8, a fixing device 60 of a third embodiment will be described. FIG. 8 is a sectional view schematically showing the fixing device 60. In the following description,the same structures as those of the fixing device 12 of the first embodiment are shown by the same reference numbers as those of the first embodiment and their detail descriptions are omitted.

A cooling part 61 of the fixing device 60 includes a heat conductive roller 62 and a moving mechanism 63.

The heat conductive roller 62 that is a heat conductive member is formed into a cylindrical shape elongated in the front and rear direction. The heat conductive roller 62 is made of heat conductive material (for example, steel, copper and aluminum-alloy). The heat conductive roller 62 is rotatably supported by the fixing frame 30.

The moving mechanism 63 supports the heat conductive roller 62 to be moved between a contact position P1 (refer to a solid line in FIG. 8) where the heat conductive roller 62 comes into contact with the pressuring roller 32 and a separate position P2 (refer to a two-dotted line in FIG. 8) where the heat conductive roller 62 is separated from the pressuring roller 32. The moving mechanism 63 has a pair of front and rear coil springs 64 (a biasing member) and a pair of front and rear eccentric cams 65. FIG. 8 shows the coil spring 64 and the eccentric cam 65 on the front side.

The pair of coil springs 64 is interposed between front and rear end portions of the heat conductive roller 62 and the fixing frame 30. Each of the air of coil springs 64 biases the heat conductive roller 62 toward the separate positon P2.

The pair of eccentric cams 65 is rotatably supported to the fixing frame 30. The pair of eccentric cams 65 is fixedly attached to a single rotating shaft. Each of the cams 65 has a substantial ellipse front view having a change in distance from a rotation center to an outer circumferential face. The pair of the eccentric cams 65 is arranged such that the outer circumferential face of each eccentric cam 65 is rubbed on the front and rear end portions of the heat conductive roller 62. Each of the eccentric cams 65 is driven by a cam motor 66 to be rotated. The cam motor 66 is electrically connected to the control device 14 to be controlled appropriately.

Next,the temperature control of the pressuring roller 32 at the duplex printing will be described. A state where the heat conductive roller 62 is moved into the separate position P2 is set to an initial state. The description for the same temperature control as that of the first embodiment is omitted.

The control device 14 executes the image forming processing as described above. The toner image on the photosensitive drum 23 is transferred on the front face F1 of the sheet S and then subjected to the first fixing processing by the fixing device 60. During the performing of the first fixing processing, the heat conductive roller 62 is kept in the state where the heat conductive roller 62 is moved into the separate position P2.

After that, the toner image on the photosensitive drum 23 is transferred on the rear face F2 of the sheet S and then subjected to the second fixing processing by the fixing device 60. Just after the end of the first fixing processing, the cam motor 66 is controlled by the control device 14 to be driven to rotate each cam 65. Each cam 65 is rotated to move the heat conductive roller 62 from the separate position P2 to the contact position P1 against biasing force of each coil spring 64 (refer to the solid line in FIG. 8). The heat conductive roller 62 moved into the contact position P1 is rotated together with the pressuring roller 32. Then, heat is transferred from the pressuring roller 32 to the heat conductive roller 62. The cam motor 66 may start to be driven in a period from the end of the first fixing processing until the start of the second fixing processing.

According to the fixing device 60 of the third embodiment as described above, the heat conductive roller 62 comes into contact with the pressuring roller 32 to remove the heat from the pressuring roller 32. As a result, the temperature difference between the fixing roller 31 and the pressuring roller 32 is regulated to control the curl amount of the sheet S at each of the first fixing processing and the second fixing processing.

In the present disclosure, the cooling part 61 of the fixing device 60 of the third embodiment may be provided in addition to the cooling part 36 of the fixing device 12 of the first embodiment (or the cooling part 51 of the fixing device 50 of the second embodiment).

In the fixing devices 12, 50 and 60 (the control device 14) of the first to third embodiments as described above, the temperature of the fixing roller 31 (the heater 34) is controlled to be constant in the period from the end of the first fixing processing until the start of the second fixing processing. However, the present disclosure is not limited to the above embodiments. For instance, as modified examples for each embodiment, the heater 34 may be controlled by the control device 14 to lower the heating amount in the period from the end of the first fixing processing until the start of the second fixing processing. In this way, the control device 14 controls the heater 34 to lower the heating amount in a period where the fixing processing is not performed. Thereby, because the temperature of the pressuring roller 32 decreases at the start of the second fixing processing, it becomes possible to increase the temperature difference between the fixing roller 31 and the pressuring roller 32.

The control device 14 of the fixing devices 12, 50 and 60 of the first to third embodiments (including the modified examples, hereinafter as the same) as described above controls the multifunctional peripheral 1 totally; the present disclosure is not limited to the control device 14. For instance, a dedicated control part which controls the fixing devices 12, 50 and 60 may be separately provided other than the control device 14.

Although each embodiment was described in a case where configurations of the disclosure are applied to the multifunctional peripheral 1 (monochromatic) as an example, the configurations of the disclosure may be applied to a color printer, a color printer, a facsimile or the like, other than the monochromatic printer 1.

While the above embodiments has been described with reference to one embodiment of the fixing device and the image forming apparatus including the fixing device according to the present disclosure. A technical scope of the disclosure is not to be restricted by the above embodiments. The components in the above embodiments may be suitably replaced with other components, or variously combined with the other components. The claims are not restricted by the description of the embodiment of the disclosure as mentioned above.

1. A fixing device comprising:
a fixing member heated by a heat source;
a pressuring member which comes into pressure contact with the fixing member to form a fixing nip;
a cooling part which cools the pressuring member heated via the fixing member; and
a control part which controls the cooling part,
wherein the fixing member and the pressuring member are rotatable and fix a toner image at least one of a front face and a rear face of a sheet passing through the fixing nip,
wherein the cooling part is controlled by the control part to lower a temperature of the pressuring member at a first fixing processing in which the toner image is fixed on the front face of the sheet compared with a second fixing processing in which the toner image is fixed on the rear face of the sheet.

2. The fixing device according to claim 1,
wherein the cooling part includes a blowing fan capable of blowing cooling air toward the pressuring member.

3. The fixing device according to claim 1,
wherein the cooling part includes:
a heat conductive member made of heat conductive material; and
a moving mechanism which supports the heat conductive member so as to be moved between a contact position where the heat conductive member comes into contact with the pressuring member and a separate position where the heat conductive member is separated from the pressuring member.

4. The fixing device according to claim 1,
wherein the heat source is controlled by the control device to lower heat amount in a period from an end of the first fixing processing until a start of the second fixing processing.

5. The fixing device according to claim 2,
wherein the heat source is controlled by the control device to lower heat amount in a period from an end of the first fixing processing until a start of the second fixing processing.

6. The fixing device according to claim 3,
wherein the heat source is controlled by the control device to lower heat amount in a period from an end of the first fixing processing until a start of the second fixing processing.

7. The fixing device according to claim 2,
wherein the cooling part includes a blowing duct which introduces the cooling air produced by the blowing fan toward the pressuring member,
the blowing fan is arranged on a main conveying path for the sheet close to an upstream side than the fixing nip.

8. The fixing device according to claim 2,
wherein the cooling part includes:
a blowing duct which introduces the cooling air produced by the blowing fan toward the pressuring member; and
a regulating valve disposed in the blowing duct and regulating flow of the cooling air,
wherein the regulating valve is controlled by the control device to close the blowing duct at the first fixing processing.

9. An image forming apparatus comprising:
an image forming part which transfers a toner image on a sheet; and
the fixing device according to claim 1, which fixes the toner image on the sheet.
